(19) United States
(12) Patent Application Publication
(10) Pub. No.: US 2019/0220994 A1
(43) Pub. Date: Jul. 18, 2019

(54) REGISTERING AND CALIBRATING PHYSICAL PROPS USED IN A VR WORLD

(71) Applicant: Unchartedvr Inc., San Rafael, CA (US)

(72) Inventors: Anthony Shafer, San Rafael, CA (US); Firat Enderoglu, Castro Valley, CA (US); Douglas Griffin, Mill Valley, CA (US)

(21) Appl. No.: 16/249,455

(22) Filed: Jan. 16, 2019

Related U.S. Application Data
(60) Provisional application No. 62/618,030, filed on Jan. 16, 2018.

(51) Int. Cl. G06T 7/73; G06T 7/521; G06T 19/00; G06F 3/0481

(52) U.S. Cl. CPC G06T 7/73; G06T 7/521; G06F 3/04815; G06T 19/006; G06T 19/003

(57) ABSTRACT

A system is described for registering and calibrating physical props in a stage use to present virtual reality (VR) experiences to players. The system comprises a scanner, a machine-based registrar, a pre-programmed VR experience, and a calibrator. The scanner scans the stage to identify physical props and their placements and orientations. The machine-based registrar registers physical props captured by the scan. The pre-programmed VR representation has predetermined places where VR objects are located, or at least perceived to be located to a player wearing a VR headset. The calibrator provides the operator with an image of the physical props overlayed with the VR representation, and signals when a physical prop is not accurately positioned and oriented. The system allows stage assemblers to visualize, and easily correct, any deviation of the physical props' locations and orientations from the predetermined places set forth in the pre-programmed VR representation.

### CROSS-REFERENCE TO RELATED APPLICATIONS

This application claims the benefit of our U.S. Provisional Patent Application No. 62/618,030, filed Jan. 16, 2018, which is herein incorporated by reference.

This application is also related to the following co-pending U.S. Patent Applications, each of which has a common assignee and common inventors.

| | FILING | |
|---|---|---|
| SER. NO. | DATE | TITLE |
| 15/783,664 | Oct. 13, 2017 | MODULAR SOLUTION FOR DELIVERING A VIRTUAL |
| (DVR.0101) | | REALITY ATTRACTION |
| 15/828,198 | Nov. 30, 2017 | METHOD FOR GRID-BASED VIRTUAL REALITY |
| (DVR.0101-C1) | | ATTRACTION |
| 15/828,257 | Nov. 30, 2017 | GRID-BASED VIRTUAL REALITY ATTRACTION SYSTEM |
| (DVR.0101-C2) | | |
| 15/828,276 | Nov. 30, 2017 | SMART PROPS FOR GRID-BASED VIRTUAL REALITY |
| (DVR.0101-C3) | | ATTRACTION |
| 15/828,294 | Nov. 30, 2017 | MULTIPLE PARTICIPANT VIRTUAL REALITY ATTRACTION |
| (DVR.0101-C4) | | |
| 15/828,307 | Nov. 30, 2017 | GRID-BASED VIRTUAL REALITY SYSTEM FOR |
| (DVR.0101-C5) | | COMMUNICATION WITH EXTERNAL AUDIENCE |
| 62/618,038 | Jan. 16, 2018 | VR SYSTEM FOR TRACKING THREE TYPES OF PHYSICAL |
| (DVR.0111) | | COMPONENTS |
| 62/624,754 | Jan. 31, 2018 | POROUS INTERACTIVE MULTI-PLAYER VR GAME |
| (DVR.0112) | | SYSTEM |
| 62/624,756 | Jan. 31, 2018 | MULTI-PLAYER VR GAME SYSTEM WITH NETWORK |
| (DVR.0113) | | PARTICIPATION |
| 62/624,760 | Jan. 31, 2018 | PLAYER-SPECIFIC VR REPRESENTATIONS OF A VR |
| (DVR.0114) | | WORLD |
| 16/241,540 | Jan. 7, 2019 | HYBRID HAND TRACKING OF PARTICIPANTS TO CREATE |
| (DVR.0115) | | BELIEVABLE DIGITAL AVATARS |
| 16/241,579 | Jan. 7, 2019 | HYBRID HAND AND FINGER MOVEMENT BLENDING TO |
| (DVR.0116) | | CREATE BELIEVABLE AVATARS |
| 62/620,378 | Jan. 22, 2018 | SAFE SPACE MECHANISM FOR VIRTUAL REALITY |
| (DVR.0117) | | GAMEPLAY |

The aforementioned applications are herein incorporated by reference for all purposes.

### BACKGROUND OF THE INVENTION

### Field of the Invention

This invention relates in general to the field of virtual reality attractions, and more particularly to virtual reality attractions that blend physical elements with VR representations.

### BRIEF DESCRIPTION OF THE DRAWINGS

These and other objects, features, and advantages of the present invention will become better understood with regard to the following description, and accompanying drawings where:

FIG. 1 illustrates one embodiment of a modular stage with a first arrangement of stage accessories to augment the illusion of a first VR experience;

FIG. 2 illustrates the modular stage of FIG. 1 with a second arrangement of stage accessories to augment the illusion of a second VR experience;

FIG. 3A illustrates the modular stage of FIG. 1 illustrating a labeled grid of separable modular stage sections, each having a plurality of peg holes for fixing the stage accessories to the modular stage;

FIG. 3B is an enlarged view of a separable modular stage section, showing a labeled secondary grid of peg holes in the modular stage section;

FIG. 4 is a perspective view of a wall equipped with pegs positioned over holes in a portion of the modular stage;

FIG. 5 illustrates a building facade accessory mounted on a modular stage;

FIG. 6 illustrates a VR representation of the building facade, embellished with an appearance of log siding and a tiled roof in a wooded surrounding;

FIG. 7 illustrates a VR participant holding a flashlight prop while pushing open a door of the building facade;

FIG. 8 illustrates a VR representation of an aged industrial doorway, with a flashlight-illuminated area that corresponds to the direction in which the flashlight prop is pointing;

FIG. 9 illustrates a VR participant walking over a wooden plank prop positioned on a modular stage platform;

FIG. 10 illustrates a corresponding VR representation of the wooden plank positioned over a deep gap separating two buildings;

FIG. 11 illustrates an elevator simulator on the modular stage;

FIG. 12 illustrates a corresponding VR representation of a VR elevator;

FIG. 13 illustrates a VR participant holding a firearm prop; and

FIG. 14 illustrates a corresponding VR representation provided to the VR participant as he holds the firearm prop.

FIG. 15 illustrates one embodiment of an inventory-management system for keeping track of and correctly aligning props.

FIG. 16 illustrates one embodiment of a method of arranging props inside an operator-managed space, registering the props, and identifying misalignments of any of the props.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached Figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

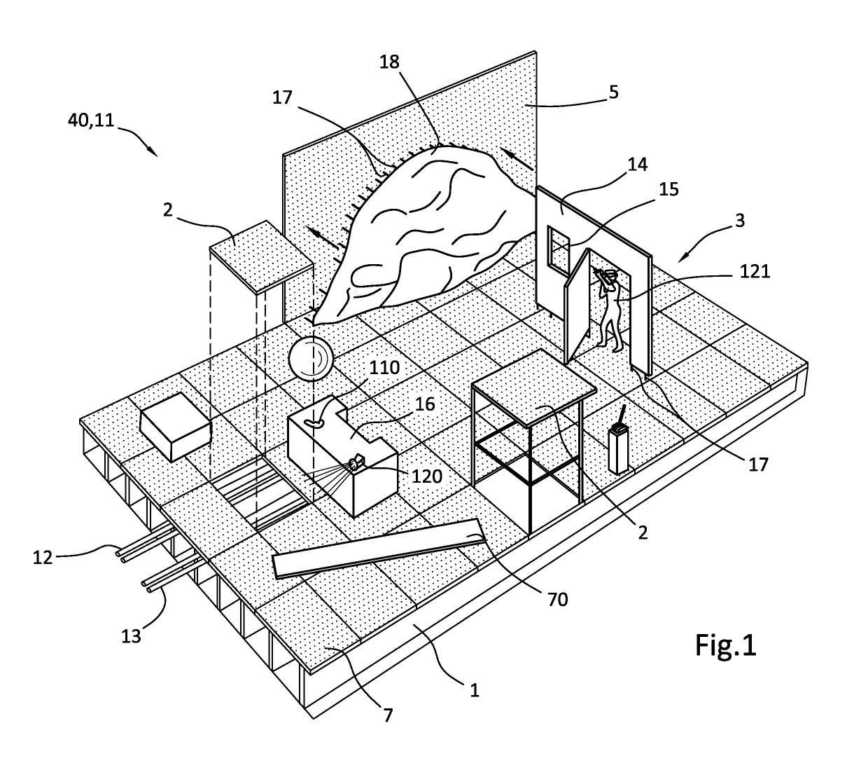

FIG. 1 illustrates one embodiment of a modular stage 1 with a first grid aligned arrangement 11 of stage accessories 14, 16, 18, 70, 110, 120 to augment the illusion of a first virtual reality (VR) experience/representation. The stage accessories 14, 16, 18, 70, 110, 120 are provided as part of a VR stage kit 11. The stage accessories 14, 16, 18, 70, 110, 120 are assembled to the stage 1 according a plurality of stage plans or arrangements that correspond to a plurality of VR representations (aka “VR worlds”) provided in a VR attraction. The stage accessories 14, 16, 18, 70, 110, 120 include set pieces and props. For example, FIG. 1 illustrates a facade 14 with a window 15 and door 6, a rock 18 attached to a perimeter wall 5, a flashlight prop 120 and a firearm prop 110 resting on a desk 16, and a plank 70 resting on a floor of a modular stage platform 3. The accessories 14, 16, 18, 70, 110, 120 give virtual reality participants sensory feedback that augments a VR representation. Some of the accessories 14, 16, 18, 70, 110, 120 may comprise fittings 17 (such as pegs) to mount them to the modular stage platform 3.

A modular stage 1 comprises a plurality of separable modular stage sections 2 designed to fit and cooperate with each other for ease of assembly to form the stage 1. The modular stage 1 and its kit 11 of stage accessories 14, 16, 18, 70, 110, 120 are configurable to fill a discrete set of spatial areas—for example, 10 meters by 20 meters and 15 meters by 15 meters—that might be found in a mall, theater, or other retail space. Different spatial representations of a VR world are created to fit one or more of these areas and correspond to one or more stage plans or arrangements of accessories 14, 16, 18, 70, 110, 120 on the stage 1.

In one embodiment, the modular stage 1 comprises a commercially available stage kit (not to be confused with the accessory kit 11 described herein). Discretely positioned (and preferably regularly spaced) accessory mounts 7 are either provided with, or incorporated into, the stage 1. In one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

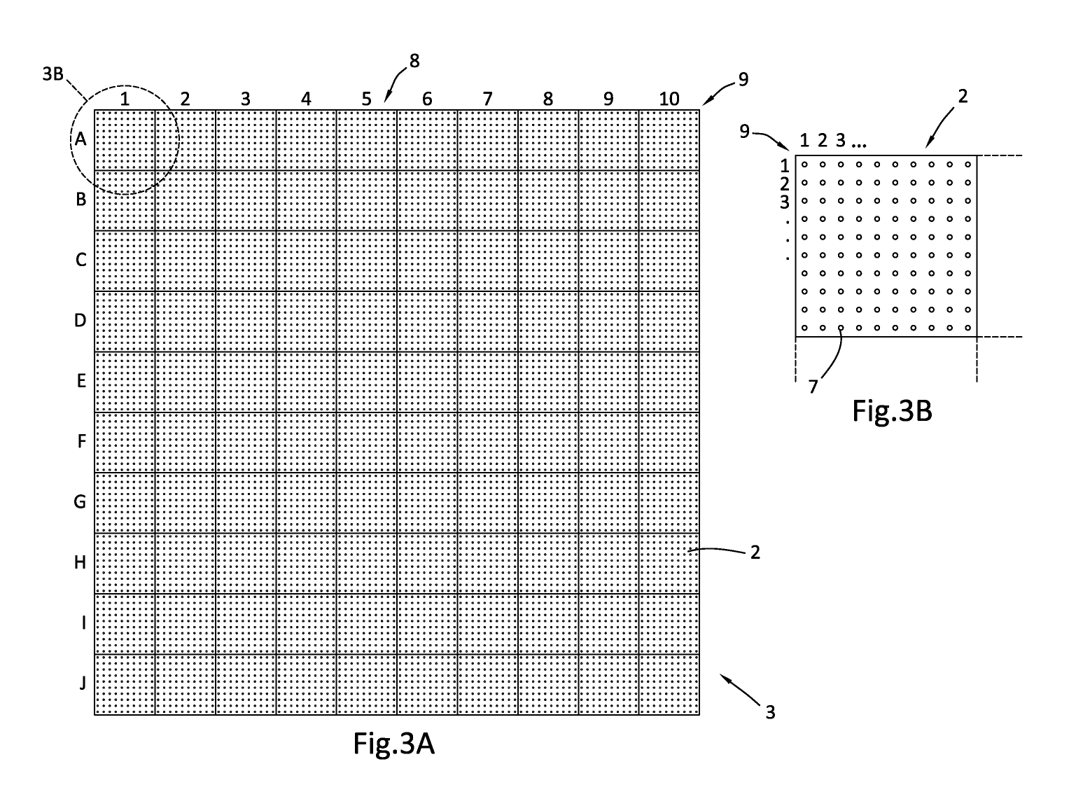

FIG. 3A illustrates a modular stage platform 3 made up of separable squares or platform sections 2. For example, each square 2 may be 1 m×1 m. FIG. 3B illustrates each square 2 as providing multiple aligned rows of accessory mounts 7 in the form of holes that are spaced 1 decimeter (for example) apart from each nearest accessory mount 7. The squares 2 are adapted to be connected to each other to create platforms 3 of different rectilinear dimensions. This enables the modular stage 1 to fit a wide range of conventional leasable commercial spaces.

The accessory mounts 7 are placed at preselected coordinates in a grid-like fashion in order to provide discrete places, readily and accurately represented in a VR world, for the mounting of the stage accessories 14, 16, 18, 70, 110, 120. In one practical embodiment, the accessory mounts 7 are peg holes that are regularly spaced and configured for receiving accessories that have cooperating pegs. In this application, the term “peg” is used in a broad sense to encompass large structures as well as small structures. The peg holes 7 may be round, square, dimensioned to receive a dimensional board, or some other shape. The peg holes 7 are defined by a surrounding structure that, in conjunction with cooperating fittings or mounts 17 (e.g., pegs), provide sufficient strength to fix and stabilize any mounted accessory 14, 16, 18, 70, 110, 120. In an alternative embodiment, the stage platform 3 is modified to incorporate pegs 17 for receiving accessories 14, 16, 18, 70, 110, 120 with cooperating holes 7.

Any suitable substitute for a peg-and-hole system would also fall within the scope of the present invention, including mounts in the form of seats, sockets, interconnectors, fasteners, couplers, couplings, clamps, hand-operated quick-release clasps, ties, pins, snaps, links, and the like. The scope of the invention also includes any arrangement of female and male parts that attach one object to another, provided that they facilitate quick assembly and disassembly.

Collectively, the peg holes or other accessory mounts 7 of the modular stage platform 3 are aligned within rectilinear rows and columns, forming a grid or regular pattern 8. In one embodiment, the stage sides have a primary set of alphanumeric markings 9, respectively, to identify each square 2 in the modular stage. In the 1 meter by 1 meter square embodiment, this grid density provides a 1 meter by 1 meter level of resolution. Each square or alternatively dimensioned platform section 2 may also be labeled with its own secondary set of alphanumeric markings 9, to identify each accessory mount 7 in the square or section 2. In the 100-holes per square embodiment, this grid density provides a 1-decimeter by 1-decimeter level of resolution. The invention is, of course, not limited to these square dimensions or grid densities.

The assembly of the accessories 14, 16, 18, 70, 110, 120 to the modular stage platform 3 makes use of the positioning grid 8. For example, as noted above, many of the accessories 14, 16, 18, 70, 110, 120 are arranged with fittings 17 (such as pegs) to mount them to the modular stage platform 3 at particular stage platform coordinates. The accessory mounts 7 cooperate with the fittings 17 to secure the accessories 14, 16, 18, 70, 110, 120 to the platform 3. This aids in fast and accurate alignment with objects in virtual reality.

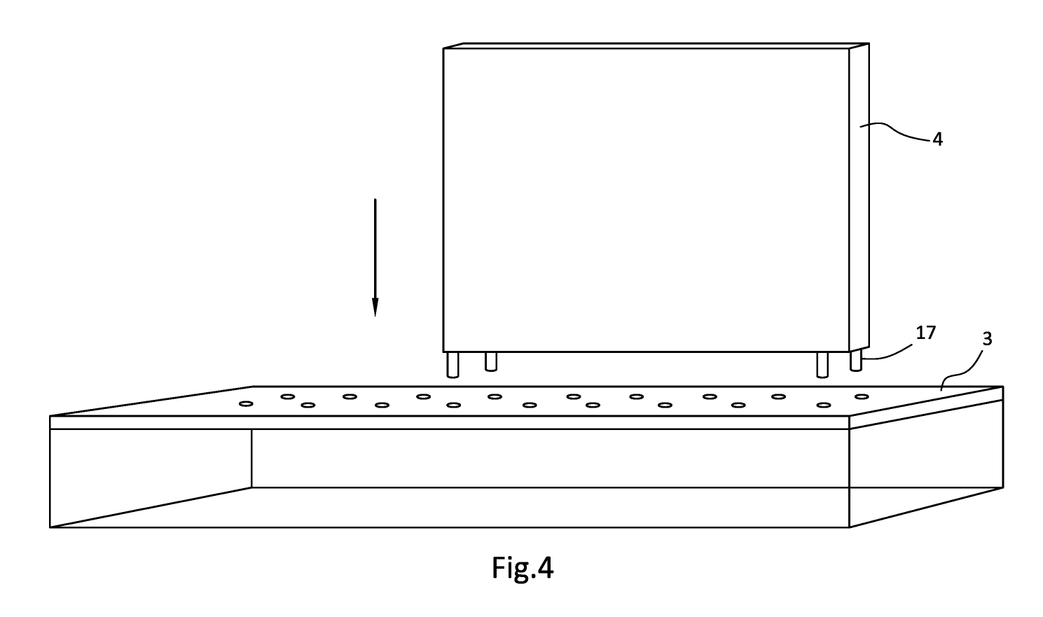

FIG. 4 illustrates this ease of assembly and disassembly by showing a wall section 5 equipped with fittings 17 in the form of pegs positioned over peg holes 7 in a portion of the modular stage platform 3. Assembling the wall section 5 may be as simple as identifying the correct holes on the grid 8 using the alphanumeric markings 9 labeling the grid 8, and inserting the pegs into the holes 7. Disassembling the wall section 5 may be as simple as lifting it from the stage 3. Quick-release clamps or connectors (e.g., clamps or connectors that do not require tools to operate) may optionally be employed, as they would only modestly increase the amount of time needed to assemble and disassemble the accessories 14, 16, 18, 70, 110, 120.

Parts may be added to or subtracted from the kit 11 to create new configurations. In one embodiment, the modular stage 1 includes perimeter walls 5 that are also covered in a labeled grid pattern 8, facilitating fastening of objects to the walls 5 in precise, discrete, exact, and vertically-aligned locations. A primary modular stage accessory 5, such as an interior wall, may include its own labeled grid and pattern of accessory mounts (not shown) so that one or more secondary modular stage accessories (e.g., rock 18 ) can be accurately mounted to the primary stage accessory 5.

The grid-based approach described above is preferable to several alternative approaches to aligning a virtual world with a physical construction. One common alternative approach is to create a permanent “one-up” VR attraction that has not been designed in a modular fashion. It is not practical to update such attractions, limiting their ability to bring in and appeal to repeat customers. Another approach would require that video sensors and/or other sensors be used to determine the location and orientation of each fixed, stationary modular stage accessory 14, 16, 18. This approach in practice would provide a less accurate and/or reliable means of aligning the virtual and physical worlds than this invention's approach, in which the objects of the VR representation and the physical world are positioned at predetermined coordinates or grid points that select prepositioned accessory mounts 7. Another alternative would involve arranging accessories 14, 16, 18, 70, 110, 120 on to the stage platform 3 at specified coordinates without the benefit of a grid 8 or a patterned arrangement of peg holes or the like. A disadvantage of this approach is that it takes longer to assemble the stage, and with greater chance of error. Another disadvantage of this approach is that stage assemblers cannot assemble a stage as precisely and quickly, this way, as they would with the grid-based approach. The result is that the physical and virtual worlds may not align as precisely as they would with the grid-based approach.

As noted above, in one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

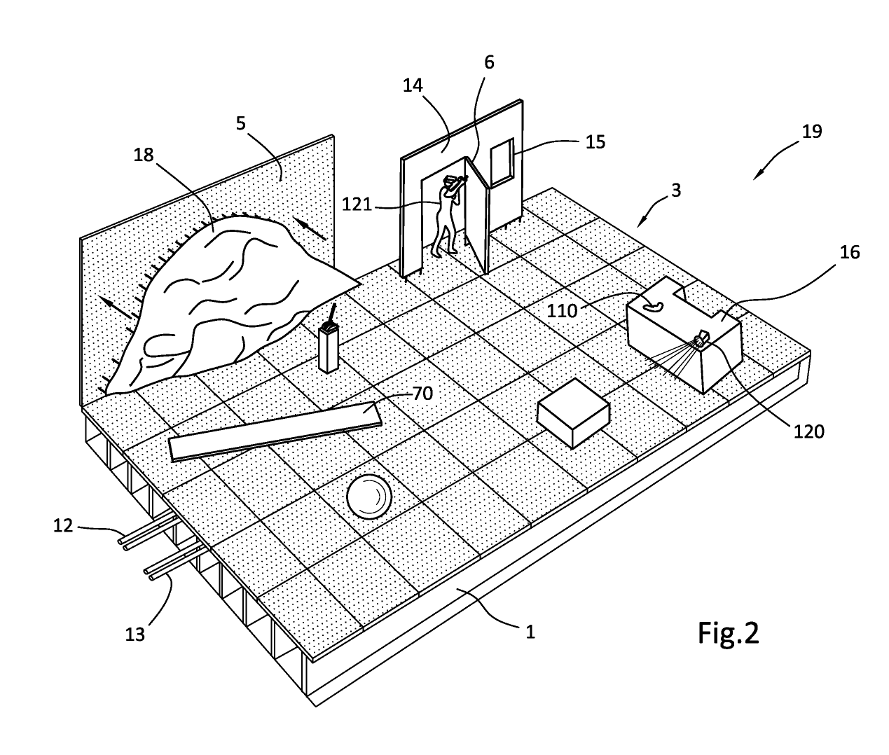

FIG. 2 illustrates the modular stage 1 of FIG. 1 with a second stage plan or arrangement 19 of stage accessories 14, 16, 18, 70, 110, 120 to augment the illusion of a second VR representation. FIGS. 1 and 2 illustrate the speed and convenience with which accessories 14, 16, 18, 70, 110, 120 can be accurately re-arranged on the stage 1 to correspond to different VR representations, with an ease that resembles rearranging Lego® blocks or placing one's ships at the start of a new Battleship® game. Advantageously, this makes it practical for proprietors to engage local customers with new experiences, keeping them coming back again and again.

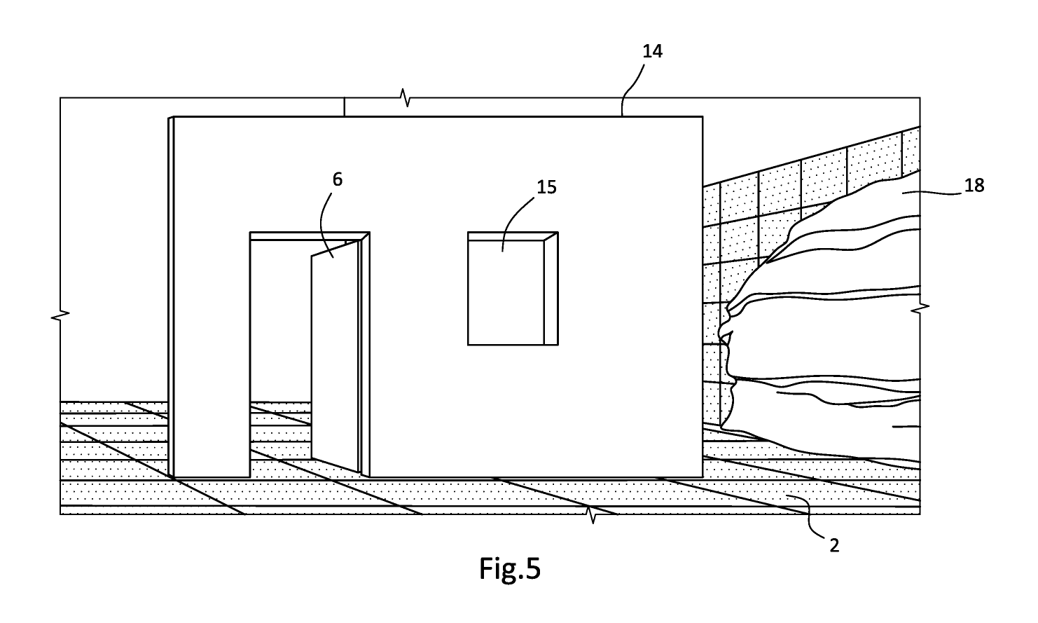

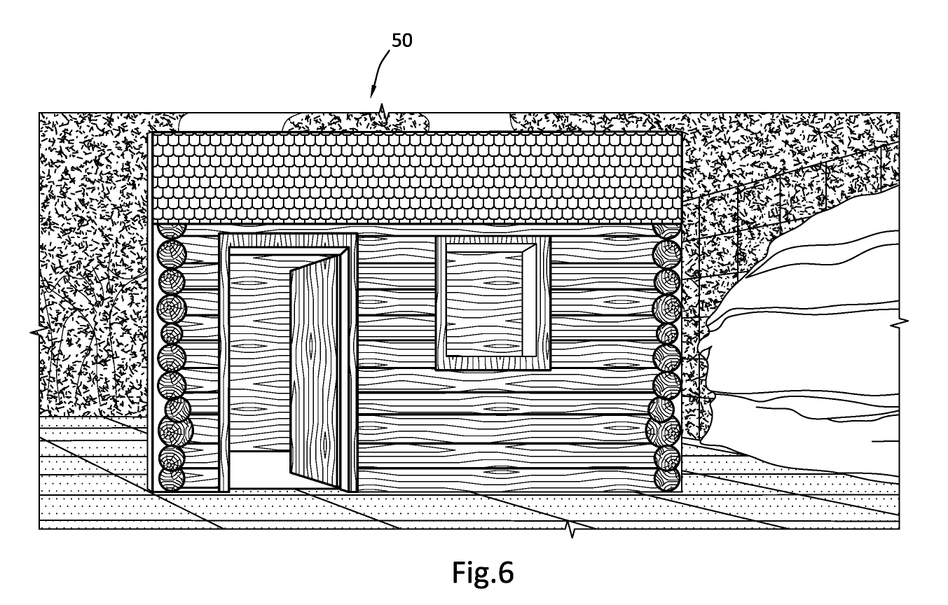

FIG. 5 illustrates a building facade 14 mounted on a modular stage. The building façade 14 comprises a door 6 and window 15 and has simple, flat dimensions. A 3D polystyrene rendering of a rock 18 has the contour of a large rock or boulder and is coated with material like sand and simulated moss to give it a rock-like tactile sensation. FIG. 6 illustrates a VR representation 50 of the building facade 14, embellished with an appearance of log siding and a tiled roof in a wooded surrounding.

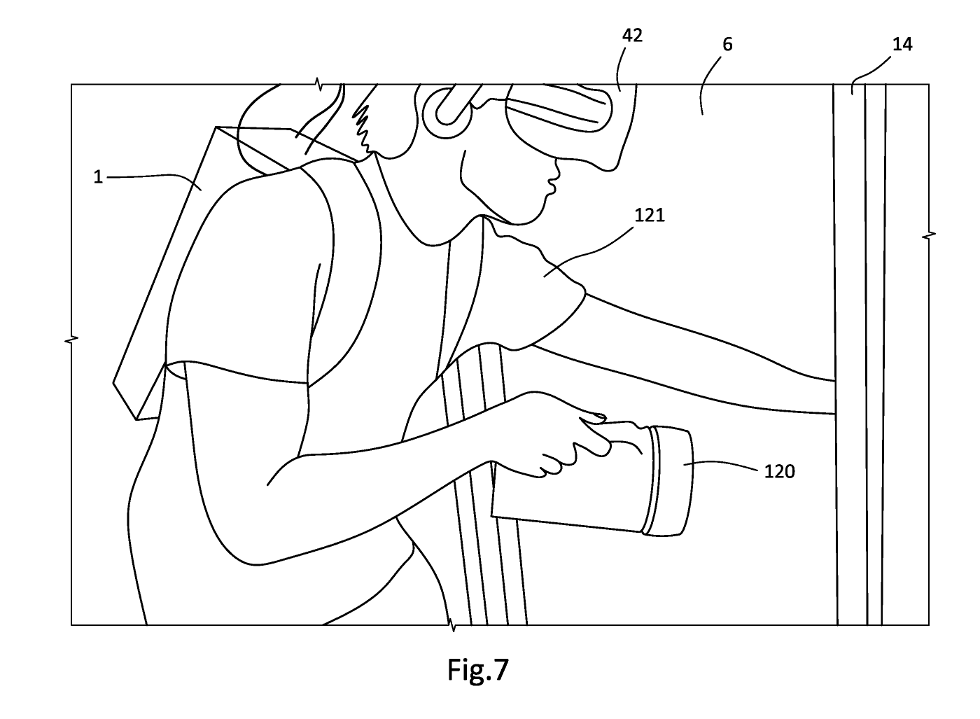

FIG. 7 illustrates a VR participant 121 carrying a backpack 41 and wearing a VR headset 42. The backpack 41 carries a computer (not shown) running a VR engine. The VR participant 121 is holding a flashlight prop 120 while pushing open the door 6 of the building façade 14. The flashlight prop 120 comprises a conventional flashlight case. To create the flashlight prop 120, any regular-sized battery, and optionally also the light bulb and lens, in the conventional flashlight case are removed. These items are replaced with a smaller power source, orientation sensors and/or a self-tracking beacon so that a motion tracking system (not shown) can determine identification, location, orientation, rotation, movement, and actuation information of the flashlight prop 120.

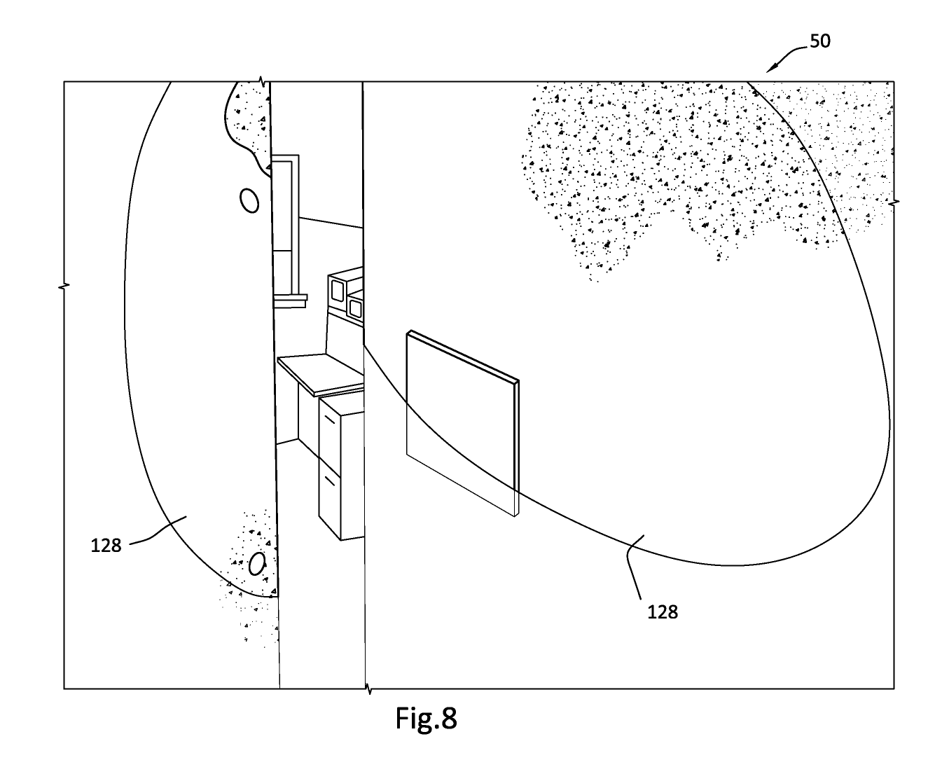

As shown in FIG. 8, a VR engine running on the computer in the backpack 41 receives the identification, location, orientation, rotation, movement, and actuation information of the flashlight prop 120 and renders a VR representation 50 of a flashlight-illuminated portion of the facade 14 and door 6, and a portion of an office beyond the facade 14. In this VR representation 50, which contrasts with the woodsy VR representation 50 of FIG. 6, the doorway is embellished to look aged, with rust spots and paint chips. Elliptical areas 128 are rendered illuminated and the areas around the elliptical areas 128 are rendered dark, corresponding to the direction in which the flashlight prop 120 is pointing. This reinforces the illusion that the sensory information received from the VR headset 42 is real.

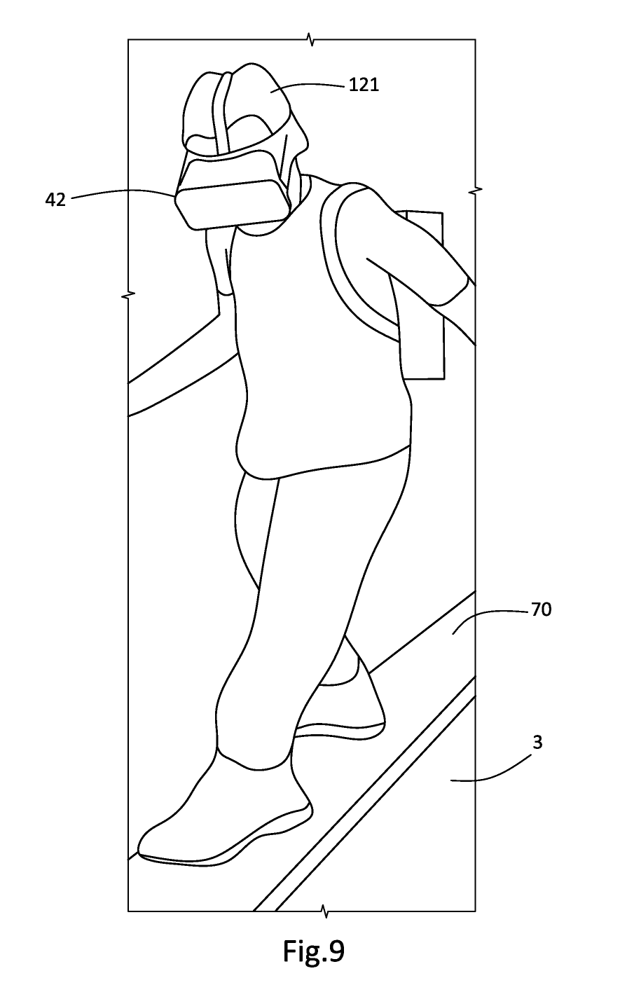

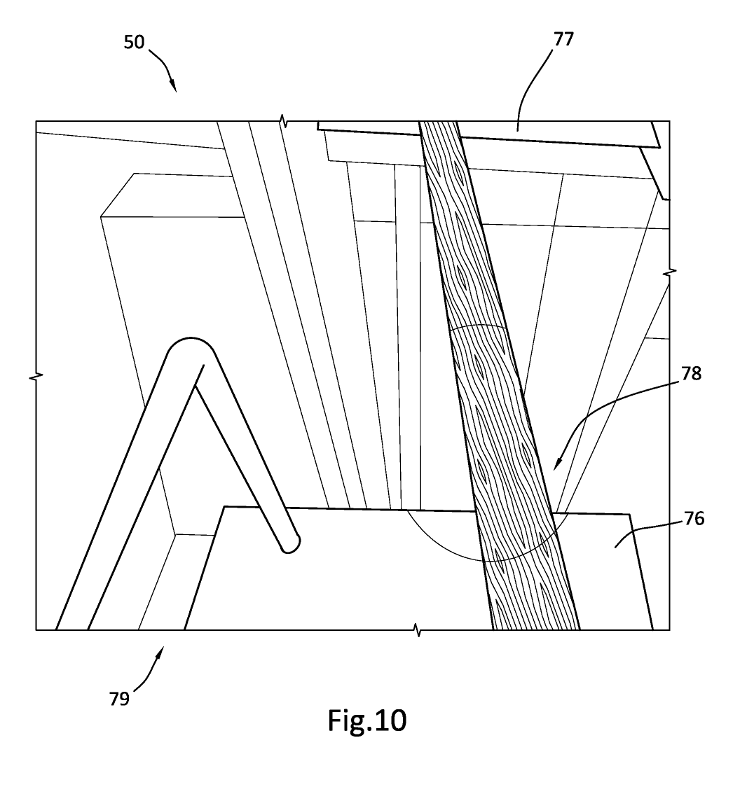

FIG. 9 illustrates the VR participant 121 walking over the wooden plank prop 70 that is shown in FIG. 1 positioned on a modular stage platform 3. The wooden plank prop 70 has a natural warp that causes it to wobble when crossed. The wooden plank prop 70, like the flashlight prop 120, is a moveable smart prop that includes orientation sensors and/or a self-tracking beacon so that a motion tracking system (not shown) can determine identification, location, orientation, rotation, and movement information of the wooden plank prop 70. The VR participant 121 walks very cautiously over the plank 70, even though the plank 70 is safely resting on the platform 3, and the VR participant 121 has a mere 1 ½ inches to fall should he lose his footing. The VR participant's fear is fueled by the VR representation 50 depicted through the participant's headset 42. As shown in FIG. 10, the VR participant 121 sees a virtual representation 79 of the plank 70 precariously spanning a deep gap 78 separating two buildings 76 and 77. And when the physical plank 70 wobbles, the motion tracking system employs the identification, location, orientation, rotation, and movement information wirelessly provided from the plank 70 to detect the wobble. Using this information, the VR engine simulates the wobble and the disorienting effect of the wobble on in the VR representation 79 of the plank 70. Sound effects, such as squeaks, wood cracking and splintering further add to the illusion of danger.

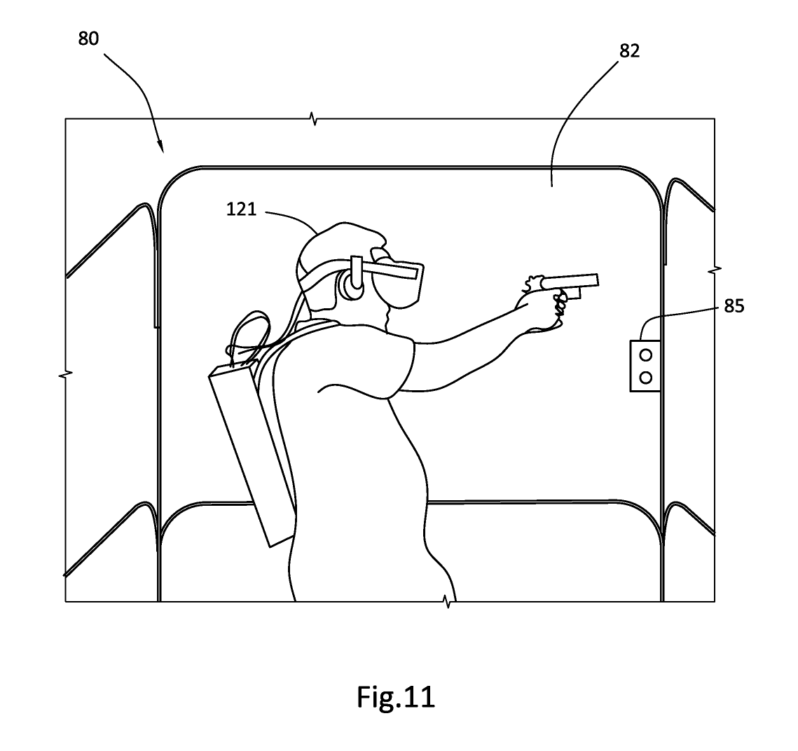

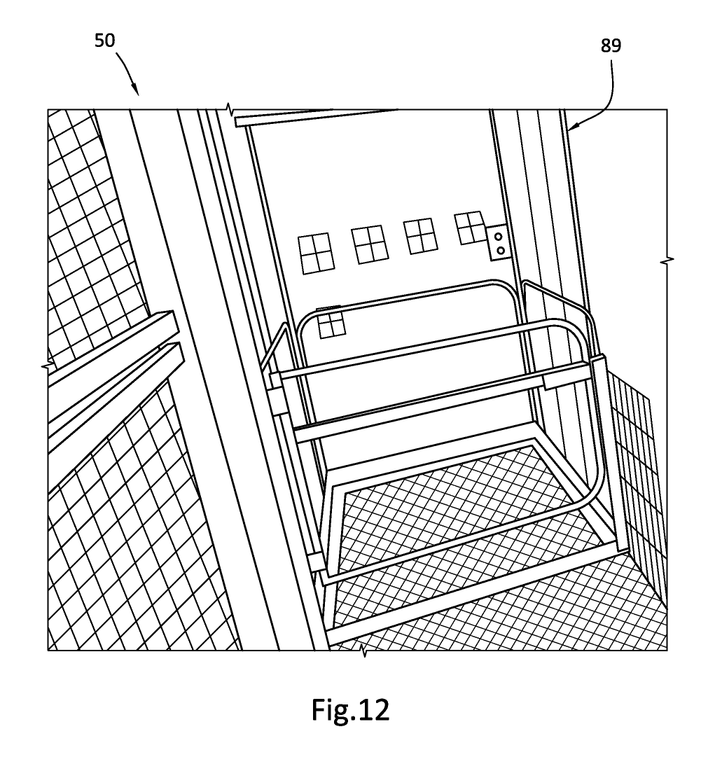

FIG. 11 illustrates the VR participant 121 in one embodiment of an elevator simulator 80 comprising an enclosure 82 made of bars, thatched plates, and/or gates. The simulator 80 may additionally comprise a controller 85 having actuators such as a switch or buttons mounted to the enclosure 82. The elevator simulator 80 is substantially stationary, moving over a span of only a few centimeters or inches to create an illusion of ascending or descending. FIG. 12 illustrates a VR representation 50 of a corresponding VR elevator 89. The VR elevator 89 is shown ascending or descending one or more floors while the corresponding elevator simulator 80 vibrates a platform (not shown) that is coupled to the enclosure 82. The elevator simulator 80 is further described in FIG. 18.

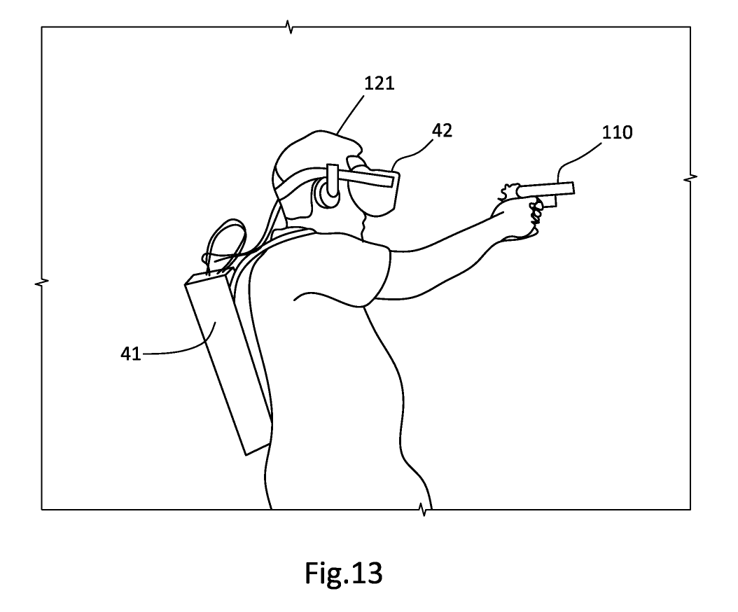

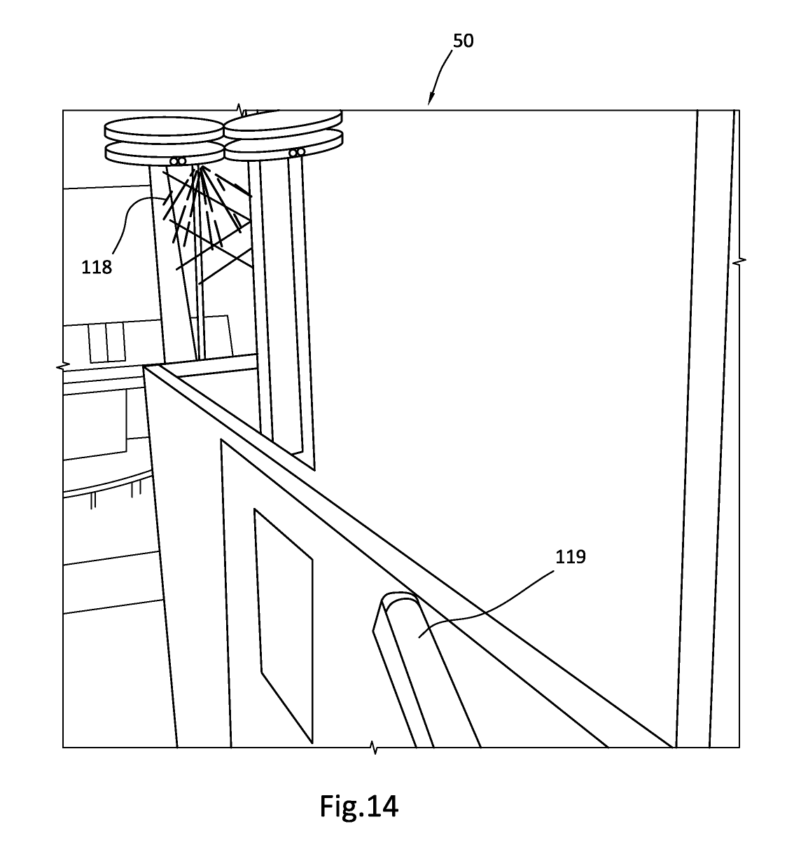

FIG. 13 illustrates the VR participant 121 holding and pointing a firearm prop 110. FIG. 14 illustrates a corresponding VR representation 50 provided to the VR participant 121 as he holds, points, and shoots the firearm prop 110. The VR representation 50 includes a depiction of a VR firearm 119 that is pointed in a direction that corresponds to the direction in which the firearm prop 110 is pointed. The VR representation 50 also depicts kill simulations 118 in response to the VR participant 121 “firing” the firearm 110.

The availability of the various aforementioned components are more than sufficient to create an immersive VR experience augmented with tactile sensations. But it would be helpful to have a tool for registering the physical props and to also calibrate their positions and orientations.

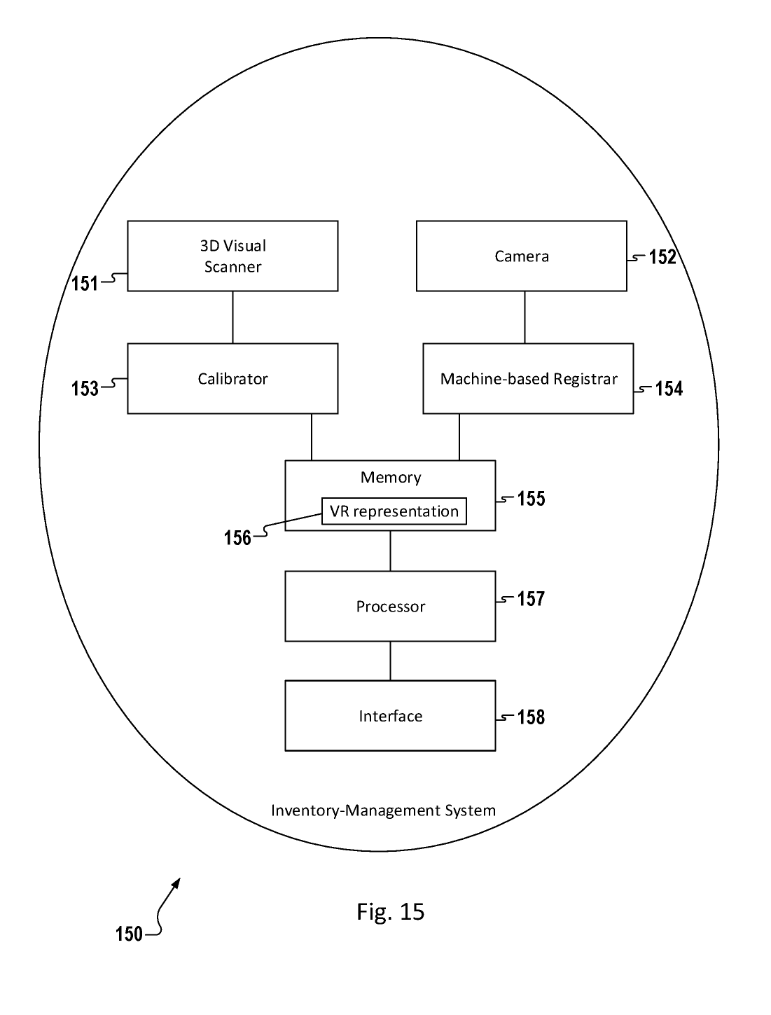

FIG. 15 illustrates one embodiment of an inventory-management system 150 for a VR setup. The inventory-management system comprises a registration component (aka machine-based registrar) 154, a scanner 151, a calibrator or comparator 153, and a processor 157, memory 154, and interface (touch-based screen) 158 which, in one implementation, is packaged within a tablet computer.

The inventory-management system utilizes 2D images from one or more cameras 152 and 3D scans from one or more 3D visual scanners 151. The one or more cameras 152 and the registration component 154 registers and accounts for physical props that are to be used in a virtual reality (VR) experience inside an operator-managed space in which the VR experience is provided to one or more participants. The scanner 151 and calibrator 153 examines the position and orientation of each prop, compares it with a planned stage setup, and informs an operator or stage manager of movements and rotations, if any, that should be made to one or more of the props to match the actual stage setup to the planned stage setup.

The registration component 154, which in one embodiment comprises an image processor 157 with software for identifying props, examines images of the operator-managed space to identify physical props. In one implementation, the registration component 154 examines images from the camera(s) 152 for symbols or retroreflective markings that identify the props. Furthermore, the registration component 154 signals the absence of any physical prop required for the VR experience.

In a further embodiment, the registration component 154 includes a database (or spreadsheet) that stores images and/or identifying information about each prop associated with a given VR representation 156, and a program of instructions to both guide how the image is to be examined, to temporarily or indefinitely store the resulting data (for example, in the database), and to specify queries or formulas to cause the database to compare the resulting data with the stored images and/or identifying information.

The 3D visual scanner 151—which may be comprised of two or more stereoscopic cameras, lidar, or an off-the-shelf 3D imager and which is not be confused with a document scanner—scans the stage and generates a 3D representation of the stage and the props on the stage.

The calibrator 153 (defined, in accordance with Wiktionary.com, as “a device that calibrates”) examines the 3D scan data and determines the orientations and positions of the props on the stage. The calibrator 153 compares virtual props required for the VR experience with props actually identified on the modular stage platform. The calibrator 153 detects if, and signals when, a physical prop is not accurately positioned and oriented. For example, in one implementation, the calibrator 154 detects and alerts an operator or stage manager about objects that do not belong on the stage and optionally also objects that are misplaced on the stage. For misplaced objects, the calibrator 154 conveys the peghole positions or coordinates at which the misplaced object should be repositioned. Alternatively, the registration component 154 conveys the number of rows and/or columns the misplaced object should be moved to correctly position it.

In an alternative embodiment, the calibrator conveys information about missing and/or misplaced objects to a VR engine responsible for merging preselected data and signal data with a VR template to generate the VR world, and further responsible for “playing” the VR world while populating it with the players' avatars. Details are discussed in U.S. patent application Ser. Nos. 16/241,540 and 16/241,579, filed Jan. 7, 2019 and herein incorporated by reference. In this implementation, the VR engine adjusts and calibrates the virtual positions and orientations of the VR props to match the actual positions and orientations of the physical props.

In another embodiment, a set of spatially spread-out symbols (such as barcodes) or lights are preplaced on each physical prop. The registration component uses the set of spread-out symbols to identify the prop. The calibrator 153 examines the spatial relationship between the symbols in the set to identify the orientation of the prop. Furthermore, the calibrator 153 uses the spatial relationship between the spread-out symbols and the pegholes 7 to determine the position of the prop on the modular stage platform 3 or positioning pattern or grid 8.

In another embodiment, an image data analysis system (IDAS) recognizes and identifies props by their shapes they form in an image. Furthermore, the IDAS recognizes the orientations of the identified props by comparing the image of the prop with 2-D projections of a 3D representation of the physical prop.

In yet another embodiment, the calibrator 153 comprises a lidar data analysis system (LDAS) that uses 3D lidar scan data to recognize and identify props by their detected 3D profile. The LDAS compares detected objects with a plurality of 3D representations of props to both identify the props and their orientation on the modular stage platform 3. In one implementation, the LDAS scales and rotates the 3D representations of the props to size and orient the 3D representation in a plurality of different ways, and then compares these scaled and rotated virtual orientations with the laser-imaged prop to find the scale and rotation that provides the best fit to the lidar scan data. In another implementation, the LDAS compares a set of angles—for example, between edges of the prop or between identifying symbols—with a corresponding set of angles of a VR prop and formulaically identifies the orientation of the physical prop.

The calibrator 153 then compares the detected position and orientation of each detected prop with the preset desired position and orientation of each prop that belongs on the modular stage platform 3. The interface 158 also displays an overlay of VR props at predetermined perceived positions and orientations over corresponding physical props. When the calibrator 153 signals that a physical prop is not accurately positioned and oriented, this is displayed through the interface 158. In this manner, the overlay reveals any physical props that are not accurately positioned and oriented.

In another embodiment, the inventory-management system is used in conjunction with a VR stage in the space. The stage has a grid-like distribution of mounting holes. One or more pegs on one or more of the physical props are used to mount the one or more physical props to the holes. In a related embodiment, the calibrator 153 also signals hole positions in which the physical props' pegs should be inserted.

In one embodiment, the calibrator 153 signals the numbers of holes along the Cartesian and orthogonal x and y axes, and optionally also the z-axis, that the physical props should be translated. In one implementation, the calibrator 153 also determines if the prop needs to be rotated around any of the axes, and if so, which ones and the direction and extent of each needed rotation.

The memory 155 stores a VR representation 156 that provides a participant the perceived position and orientation of the corresponding VR props. The memory 155 also stores instructions and provides working memory for the calibrator 153 and registration component. The instructions are configured according to a format and syntax that is compatible with the instruction set architecture of the processor 157 and the operating system which runs on the processor 157.

The processor 157 executes instructions for performing inventory management and for superimposing the VR representation 156 of the space onto image(s) of the physical props. The interface 158 displays the superimposed VR representation 156 over the image(s) of the physical props. The interface 158 also enables a manger to control and update the inventory-management system.

In other embodiments, one or more of the functions described above as being performed by the camera and/or registration component are performed instead by the 3D visual scanner 151 and/or calibrator 153. The inverse applies as well. Accordingly, the potential scope of this invention encompasses any combination of the aforementioned embodiments and implementations to identify the presence, orientation, and/or position of props on the modular stage platform 3.

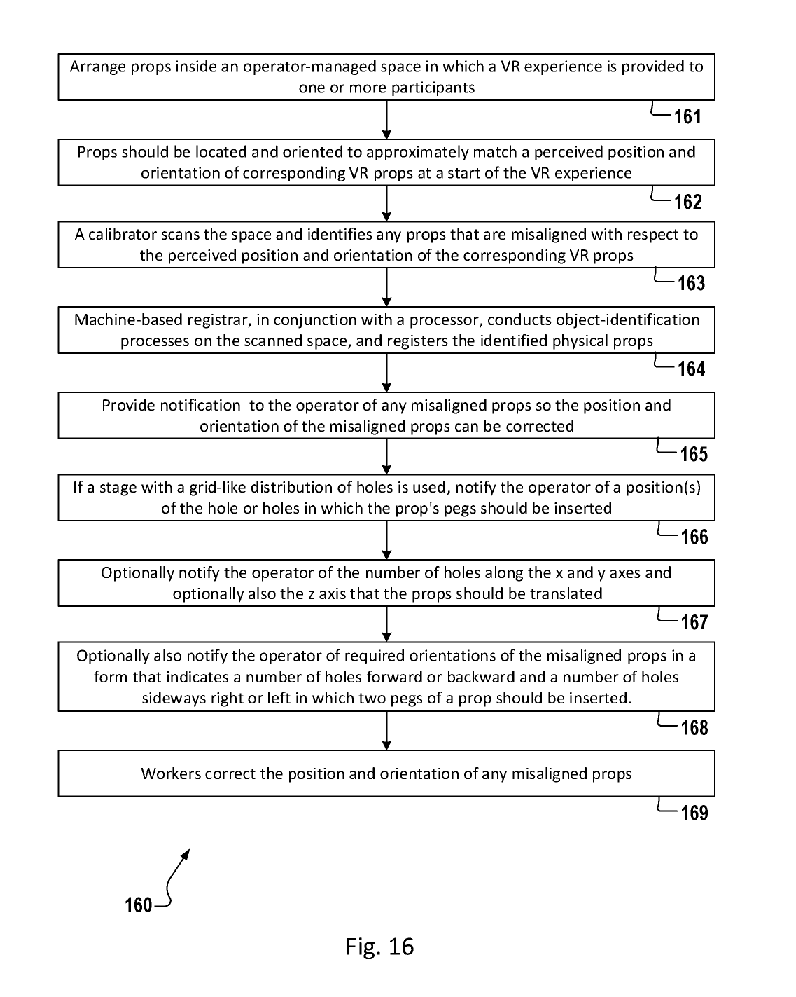

FIG. 16 is flow chart of a method of aligning physical props selected for use within a virtual reality (VR) experience inside an operator-managed space in which the VR experience is provided to one or more participants. In block 161, the props are arranged inside the space to approximately match a perceived position and orientation of corresponding VR props at a start of the VR experience. As more particularly set forth in block 162, props should be located and oriented to approximately match a perceived position and orientation of corresponding VR props at a start of the VR experience. In block 163, a calibrator 153 scans the space and identifies any props that are misaligned with respect to the perceived position and orientation of the corresponding VR props. In block 164, the calibrator 153 or a machine-based registrar 154 conducts object-identification processes on the scanned space and also registers the physical props as the calibrator 153 scans the space. In block 165, the inventory-management system provides notification to the operator of the misaligned props so the position and orientation of any misaligned props can be corrected. As set forth in block 166, if a stage with a grid-like distribution of holes is used, notify the operator of a position(s) of the hole or holes in which the prop's pegs should be inserted. Alternatively, as set forth in block 167, notify the operator of the number of holes along the x and y axes and optionally also the z axis that the props should be translated. In a slightly different implementation set forth in block 168, notify the operator of required orientations of the misaligned props in a form that indicates a number of holes forward or backward and a number of holes sideways right or left in which two pegs of a prop should be inserted. In block 169, workers correct the position and orientation of any misaligned props.

In one embodiment, the space includes a stage having a grid-like distribution of mounting holes and the props each have one or more pegs to mount in the holes. In one instantiation of this embodiment, the method further comprises the calibrator 153 notifying the operator of a position of the hole or positions of the holes in which the prop's or props' pegs should be inserted. In the same or another instantiation of this embodiment, the method further comprises the calibrator 153 notifying the operator of numbers of holes along orthogonal x and y axes that the props should be translated. In the same or yet another instantiation of this embodiment, the calibrator 153 notifies the operator of numbers of holes along a vertical z-axis, orthogonal to the x and y axes, that the props should be translated.

In a related instantiation, the calibrator 153 notifies the operator of required orientations of props in a form that indicates a number of holes forward or backward and a number of holes sideways right or left in which two pegs of a prop should be inserted.

Turning to more structural details, the calibrator 153 utilizes an image of the props captured through the camera, a 3D map of the setup generated by the scanner 151, and a VR representation 156 stored in the memory 155. The calibrator 153 also uses the processor 157 to superimpose the VR representation 156, or a partially transparent version thereof, on the image of the props. The image of the props, superimposed with the VR representation 156, is sent to the interface 158 to enable an authorized worker to view any misalignments. The VR representation 156 is dependent upon and consistent with a position and orientation in which the calibrator 153 is held and provides a participant the perceived position and orientation of the corresponding VR props.

The invention can also be characterized as a VR setup for providing a VR experience to one or more participants. The VR setup comprises one or more VR headsets, a plurality of physical props, a pre-programmed VR experience, and a calibrator. The VR headsets are provided to the one or more participants. The physical props provide a tactile sensation that enhances audiovisual components of the VR experience. The pre-programmed VR experience provides the one or more participants an immersive audiovisual experience of a virtual world through the one or more VR headsets. The calibrator 153 scans a space in which the VR experience is provided. The calibrator 153 identifies any physical props that are misaligned with respect to the perceived position and orientation of the corresponding VR props.

It will be understood that various structures of the invention, including the registrar 154 and the calibrator 153, may be in the form of a computer or a binary-coded writeable memory 155 that stores data and software instructions and a processor 157 that translates, schedules, and executes them. Alternatively, the registrar 154 and calibrator 153 may be in the form of a non-general-purpose customized digital system, in which some of the instructions and data are hard-coded and/or utilize programmed read-only-memory.

I claim:

1. An inventory-management system for a VR setup, the inventory-management system comprising:
a machine-based registrar that registers physical props that are to be used in a virtual reality (VR) experience inside an operator-managed space in which the VR experience is provided to one or more participants;
a calibrator that calibrates actual positions and orientations of the physical props with corresponding perceived positions and orientations of VR props at a start of the VR experience;
the calibrator signaling when a physical prop is not accurately positioned and oriented.

2. The inventory-management system of claim 1, further comprising a scanner that scans the operator-managed space to identify physical props and their placements and orientations.

3. The inventory-management system of claim 2, further comprising an interface through which the calibrator signals that a physical prop is not accurately positioned and oriented, wherein the interface also displays an overlay of VR props at predetermined perceived positions and orientations over corresponding physical props, the overlay revealing any physical props that are not accurately positioned and oriented.

4. The inventory-management system of claim 1, the calibrator also signaling the absence of any physical prop required for the VR experience.

5. The inventory-management system of claim 1, the calibrator also registering presences of physical props required for the VR experience.

6. The inventory-management system of claim 2, further comprising a stage in the space having a grid-like distribution of mounting holes, wherein one or more pegs on one or more of the physical props are used to mount the one or more physical props on the holes.

7. The inventory-management system of claim 6, wherein the calibrator signals a position of the hole or positions of the holes in which the physical prop's or props' pegs should be inserted.

8. The inventory-management system of claim 7, wherein the calibrator notifies the operator of numbers of holes along orthogonal x and y axes that the physical props should be translated.

9. The inventory-management system of claim 8, wherein the calibrator also notifies the operator of numbers of holes along an orthogonal and vertical z-axis that the physical props should be translated.

10. The inventory-management system of claim 1, wherein the calibrator comprises an input, a memory, a processor and an interface, wherein the method further comprises the input collecting an image of the physical props, the memory storing a VR representation that provides a participant a perceived position and orientation of the corresponding VR props, and the processor and interface superimposing the VR representation of the space onto the physical props.

11. A method of aligning props selected for use within a virtual reality (VR) experience inside an operator-managed space in which the VR experience is provided to one or more participants, the method comprising:
arranging the props inside the space to approximately match a perceived position and orientation of corresponding VR props at a start of the VR experience;
utilizing a calibrator to scan the space and identify any props that are misaligned with respect to the perceived position and orientation of the corresponding VR props;
providing notification to the operator of the misaligned props so the position and orientation of any misaligned props can be corrected.

12. The method of claim 11, further comprising correcting the position and orientation of any misaligned props.

13. The method of claim 12, wherein the space includes a stage having a grid-like distribution of mounting holes and the props each have one or more pegs to mount in the holes, the method further comprising the calibrator notifying the operator of a position of the hole or positions of the holes in which the prop's pegs should be inserted.

14. The method of claim 12, wherein the space includes a stage having a grid-like distribution of mounting holes and the props each have one or more pegs to mount in the holes, the method further comprising the calibrator notifying the operator of numbers of holes along orthogonal x and y axes that the props should be translated.

15. The method of claim 14, wherein the calibrator also notifies the operator of numbers of holes along an orthogonal and vertical z-axis that the props should be translated.

16. The method of claim 14, wherein the calibrator notifies the operator of a required orientation of a prop in a form that indicates a number of holes forward or backward and a number of holes sideways right or left in which two pegs of the prop should be inserted.

17. The method of claim 11, wherein the calibrator comprises an input, a memory, a processor and an interface, wherein the method further comprises the input collecting an image of the props, the memory storing a VR representation that provides a participant the perceived position and orientation of the corresponding VR props, and the processor and interface superimposing the VR representation onto the corresponding props.

18. The method of claim 17, wherein the VR representation stored in the memory is a VR representation that is dependent upon and consistent with a position and orientation in which the calibrator is held.

19. The method of claim 11, the calibrator also signaling the absence of any prop required for the VR experience.

20. A VR setup for providing a VR experience to one or more participants, the VR setup comprising:
one or more VR headsets that are provided to the one or more participants;
a plurality of physical props that provide a tactile sensation that enhances audiovisual components of the VR experience;
a pre-programmed VR experience in which the one or more participants are provided an immersive audiovisual experience of a virtual world through the one or more VR headsets; and
a calibrator that is used to scan a space in which the VR experience is provided, the calibrator identifying any physical props that are misaligned with respect to the perceived position and orientation of the corresponding VR props.
